(19) United States
(12) Patent Application Publication
(10) Pub. No.: US 2025/0310901 A1
(43) Pub. Date: Oct. 2, 2025

(54) METHOD AND APPARATUS FOR POWER HEADROOM REPORT

(71) Applicant: Nokia Technologies Oy, Espoo (FI)

(72) Inventors: Chunli WU, Beijing (CN); Samuli Heikki TURTINEN, Ii (FI); Tero HENTTONEN, Espoo (FI)

(21) Appl. No.: 18/866,601

(22) PCT Filed: May 24, 2022
(86) PCT No.: PCT/CN2022/094800

§ 371 Date: Nov. 18, 2024

(51) Int. Cl. H04W 52/36

(52) U.S. Cl. CPC H04W 52/365

(57) ABSTRACT

Embodiments of the present disclosure relate to power headroom report in dual connectivity. A terminal device obtain a power headroom reporting indication, which indicates disabling cross cell group PH reporting, wherein PH information of activated serving cells of both the first cell group and the second cell group are reported in the cross cell group PH reporting; and create, based on the PH reporting indication, a PH report, including PH information regarding one of the first cell group and the second cell group. In this way, signaling overhead and power consumption can be reduced.

### FIELD

Embodiments of the present disclosure generally relate to the field of communication, and in particular, to a method, devices, apparatus and computer readable storage medium for power headroom (PH) report (PHR).

### BACKGROUND

With development of communication technology, terminal devices may be served by a master cell group (MCG) and a secondary cell group (SCG) simultaneously, which may also be called dual connectivity (DC), to improve communication capacity and coverage.

In dual connectivity scenarios, such as dual connectivity in Long Term Evolution (LTE DC), Evolved Universal Terrestrial Radio Access (E-UTRA)-New Radio (NR) Dual Connectivity (EN-DC), NR-E-UTRA Dual Connectivity (NE-DC), NR Dual Connectivity (NR-DC), many PH Report (PHR) triggers are for both Medium Access Control (MAC) entities.

In a conventional PHR procedure, the uplink (UL) transmission power used for one cell group might impact UL power allocation in another cell group as well in case of dynamic power sharing, and therefore, PH for all the active serving cells from both cell groups are reported to both base stations. In other words, whenever a PHR is reported, PH for all active serving cells for both cell groups would be reported.

### SUMMARY

In general, example embodiments of the present disclosure provide a method, apparatus and computer readable storage medium for power headroom reporting in dual connectivity.

In a first aspect, there is provided a terminal device. The terminal device may comprise one or more transceivers; and one or more processors communicatively coupled to the one or more transceivers, wherein the terminal device is configured with dual connectivity with a first cell group and a second cell group, and the one or more processors are configured to cause the terminal device to obtain a power headroom (PH) reporting indication, which indicates disabling cross cell group PH reporting, wherein PH information of activated serving cells of both the first cell group and the second cell group are reported in the cross cell group PH reporting; and create, based on the PH reporting indication, a PH report, PHR, including PH information regarding one of the first cell group and the second cell group.

In a second aspect, there is provided a network device. The network device may comprise one or more transceivers; and one or more processers communicatively coupled to the one or more transceivers, and configured to cause the network device to transmit a configuration regarding uplink power control or power headroom report configuration, which explicitly or implicitly indicates disabling cross cell group PH reporting, wherein PH information of activated serving cells of both a first cell group and a second cell group are reported in the cross cell PH reporting; and receive a PH report, PHR, including PH information regarding one of the first cell group and the second cell group.

In a third aspect, there is provided a method implemented at a terminal device. The method may comprise obtaining a power headroom (PH) reporting indication, which indicates disabling cross cell group PH reporting, wherein PH information of activated serving cells of both the first cell group and the second cell group are reported in the cross cell group PH reporting; and creating, based on the PH reporting indication, a PH report, PHR, including PH information regarding one of the first cell group and the second cell group.

In a fourth aspect, there is provided a method implemented at a network device. The method may comprise transmitting a configuration regarding uplink power control or PHR configuration, which explicitly or implicitly indicates disabling cross cell group PH reporting, wherein PH information of activated serving cells of both a first cell group and a second cell group are reported in the cross cell group PH reporting; and receiving a PH report, PHR, including PH information regarding one of the first cell group and the second cell group.

In a fifth aspect, there is provided an apparatus of terminal device. The apparatus may comprise means for obtaining a power headroom (PH) reporting indication, which indicates disabling cross cell group PH reporting wherein PH information of activated serving cells of both the first cell group and the second cell group are reported in the cross cell group PH reporting; and means for creating, based on the PH reporting indication, a PH report, PHR, including PH information regarding one of the first cell group and the second cell group.

In an sixth aspect, there is provided an apparatus of network device. The apparatus may comprise means for transmitting a configuration regarding uplink power control or PHR configuration, which explicitly or implicitly indicates disabling cross cell group PH reporting wherein PH information of activated serving cells of both a first cell group and a second cell group are reported in the cross cell group PH reporting; and means for receiving a PH report, PHR, including PH information regarding one of the first cell group and the second cell group.

In a seventh aspect, there is provided a non-transitory computer readable medium comprising program instructions for causing an apparatus to perform at least the method according to third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates a flowchart of a method implemented at a terminal device according to some embodiments of the present disclosure;

FIG. 3 illustrates a PHR MAC CE format which can be used to implement example embodiments of the present disclosure;

FIG. 4 illustrates a flowchart of a method implemented at a network device according to some other embodiments of the present disclosure;

FIG. 5 illustrates a signaling chart illustrating an example PHR procedure in DC according to some example embodiments of the present disclosure;

FIG. 6 illustrates a simplified block diagram of an apparatus that is suitable for implementing embodiments of the present disclosure; and

FIG. 7 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/of” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, PHR could be triggered to provide difference between the maximum allowable transmission power for a terminal device and the uplink transmission power currently evaluated between the estimated uplink transmission power and the UE maximum transmission power to gNB. Thus, the gNB can control power and schedule resource for the terminal device based on the PHR.

Typically, the PHR may be triggered in the following cases:
phr-ProhibitTimer expires or has expired and the path loss has changed exceeds the threshold; phr-PeriodicTimer expires;
upon configuration or reconfiguration of the power headroom reporting functionality by upper layers, which is not used to disable the function; activation of an SCell of any MAC entity with configured uplink of which firstActiveDownlinkBWP-Id is not set to dormant bandwidth part (BWP); activation of an SCG;
addition of the PSCell except if the SCG is deactivated (i.e. PSCell is newly added or changed);
upon switching of activated BWP from dormant BWP to non-dormant DL BWP of an SCell of any MAC entity with configured uplink, and so on.

However, in dual connectivity scenarios, such as LTE DC, EN-DC, NE-DC, NR-DC, many PH Report (PHR) triggers are for both Medium Access Control (MAC) entities. In other words, whenever a PHR is reported, PH information for all active serving cells for both cell groups would be reported, which may also be called, but not limited to cross cell group PH reporting for simplification purposes. However, such PH reporting will cause higher PHR overhead due to PH information for both cell groups to be reported.

According to embodiments of the present disclosure, there is providing a solution for power headroom reporting. In this solution, a terminal device obtains a PH reporting indication, which indicates disabling cross cell group PH reporting. In the cross cell group PH reporting, PH information of activated serving cells of both the first cell group and the second cell group are reported and a PH reporting indication disabling cross cell group PH reporting may also be called cross cell group PH reporting disabling indication. Moreover, the terminal device creates a PHR based on the PH reporting indication, and the PHR including PH information regarding one of the first cell group and the second cell group. The one of the first cell group and the second cell group regarding which PH information is included in the PHR may be a cell group meeting a PHR trigger condition or a cell group associated with a MAC entity meeting a PHR trigger condition. As such, in embodiments of the present disclosure, the cross cell group PH reporting may be disabled explicitly or implicitly when cross cell group PH are not to be used, thereby reducing PHR overhead.

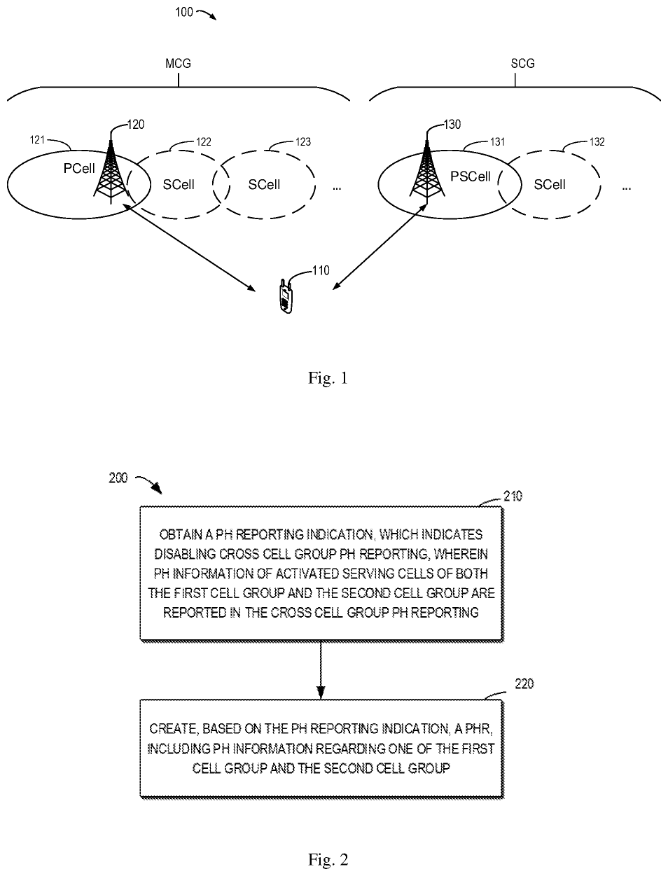

Example embodiments of the present disclosure for PH reporting will be described below with reference to FIGS. 1-6.

FIG. 1 illustrates an example network environment 100 in which example embodiments of the present disclosure may be implemented. The environment 100, which may be a part of a communication network, comprises terminal devices and network devices.

As illustrated in FIG. 1. in the network environment 100, a first device 110 is configured with carrier aggregation (CA) and in dual-connectivity (DC) with a second device 120 and a third device 130. The first device 110 may be implemented as the terminal device (which may be also referred to as the terminal device 110 or UE 110 hereinafter). The second device 120 and the third device 130 may be network devices (which may be referred to as gNBs 120 and 130, or network devices 120 and 130), such as, base stations for providing radio coverage to the first device 110.

In dual connectivity (DC) mode, a terminal device can be served by a master cell group (MCG) and a secondary cell group (SCG). The MCG may be a group of serving cells associated with the master radio access network (RAN) node, and it could be understand as the cell group, which a cell in which UE first initiates random access (RACH) belongs to. There may be a plurality of cells in the MCG, the cell in which the UE first initiating the initial access is called Primary Cell (PCell), other cells are called SCell (Secondary Cell). The PCell and SCell in MCG may be combined by means of CA technology. Similarly, there is a primary cell in the SCG, which called Primary Secondary Cell (PSCell), the PSCell can also be simply understood as the cell where the initial access is initiated in the SCG. In addition, the SCG may optionally comprise one or more SCells.

As shown in FIG. 1, the second device 120 provides and manages the MCG including a PCell 121. The PCell 121 may operate on a primary frequency, in which the first device 110 either performs the initial connection establishment procedure or initiates the connection re-establishment procedure. The PCell 121 is assumed to be always activated. The third device 130 provides and manages the SCG including a PScell 131.

For each of the MCG and SCG, there may be one or more SCell, for example, SCells 122, 123 and 132 configured for providing additional radio resources to the first device 110. However, SCell is not essential for DC operations, and in some cases, there may be no SCell included in either MCG or SCG. It should be noted that the numbers of SCells included in the MCG and SCG are given for illustrative purpose. Depending on network deployment, resource configuration, actual demands, etc., there may be more or less SCells in each of MCG and SCG.

The first device 110 may communicate with the second device 120 and/or the third device 130 on uplink (UL) or downlink (DL). In particular, the direction from the first device 110 to the second device 120 and/or the third device 130 refers to uplink (UL), and the direction from the second device 120 and/or the third device 130 to the first device 110 refers to downlink (DL).

During operating, the first device 110 may determine whether there is a power headroom (PH) reporting indication, which indicates disabling cross cell group PH reporting and create the PHR regarding one of MCG and SCG to provide power information to the MCG or SCG, i.e., the second device 120 or the third device 130.

In a scenario of power split between the two cell groups, the gNB can configure maximum transmission power for each cell group. The maximum transmit power that the UE may use on this serving cell may be additionally limited by p-NR-FR1 (configured for the cell group) and by p-UE-FR1 (configured total for all serving cells operating on FR1). In such a case, if the sum of total power for two cell groups is not higher than the UE's maximum transmit power, then the terminal device and the network devices are operating in static power allocation mode without dynamic power sharing between cell groups. In such a case, an explicit or implicit power headroom (PH) reporting indication can be provided when cross cell group PH reporting are not intended to be used by the NW to reduce PH overhead, thereby improving system performance and system efficiency. The term “cross cell group” used herein may refer to providing information of one cell group (e.g., MCG or SCG) to another cell group (e.g., SCG or MCG), and the term “cross cell group PH reporting” may refer to reporting PH information of one cell group (e.g., MCG or SCG) to another cell group (e.g., SCG or MCG). For example, with “cross cell group PH reporting,” the UE would report PH of the cells associated with the SCG in a PHR transmitted to MCG, or report PH of the cells associated with MCG in a PHR transmitted to SCG. In other words, in the cross cell group PH reporting mode, PH information regarding both SCG and MCG will be reported. On the other hand, when the “cross cell group” or “cross cell group PH reporting” is disabled or not allowed, the UE may not report PH of the cells associated with one of the cell groups (e.g., MCG or SCG) to another cell group (e.g., SCG or MCG), but report PH of the cells associated with one of the cell groups (e.g., MCG or SCG) to the one cell group (e.g., MCG or SCG) only.

In addition, in NR Rel-17, more enhanced PHR formats (e.g. Enhanced Multiple Entry PHR MAC CE, Enhanced Multiple Entry PHR for multiple transmit receive points (TRP) MAC CE) are introduced for Further enhanced MIMO (FeMIMO) with multiple beams/TRPs, in order to report more information for each serving cell, e.g. Multiple Point of Entry (MPE) for multiple beams, PH values for multiple TRPs, etc. In such a case, it would also further increase the PHR overhead. In an example, one of gNBs supports FeMIMO while the other gNB does not, and the gNB that does not support FeMIMO would not be able to decode the additional information or benefit from it. In another example, one MAC entity is not configured with two-PHR mode for m-TRP (e.g., MAC entity associated with the node not supporting FeMIMO) and then only one PH from the multiple PHs for a serving cell is reported, such that it does not work well either since it does not include full information about the power situation. This may lead to erroneous scheduling decisions by the node that does not use/support FeMIMO. By providing such an explicit or implicit power headroom (PH) reporting indication, it is possible to address the problem to reduce the PH overhead, thereby improving system performance and system efficiency. In addition, operations for FeMIMO can be simplified when only one gNB supports FeMIMO. Therefore, this solution could facilitate flexible and efficient power headroom reporting also.

According to some embodiments, for backward compatibility purposes, in addition to power information on the MCG, the PHR may also include power information for Pcell of the SCG via, for example, PSCell 131 PH entry, especially for an implicit PH report indication. Thus, it could reduce PH overhead while still keeping the backward compatibility.

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

Communications in the network environment 100 may be implemented according to any proper communication protocol(s), comprising, but not limited to, the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Multiple-Input Multiple-Output (MIMO), Orthogonal Frequency Division Multiplexing (OFDM), time division multiplexing (TDM),frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

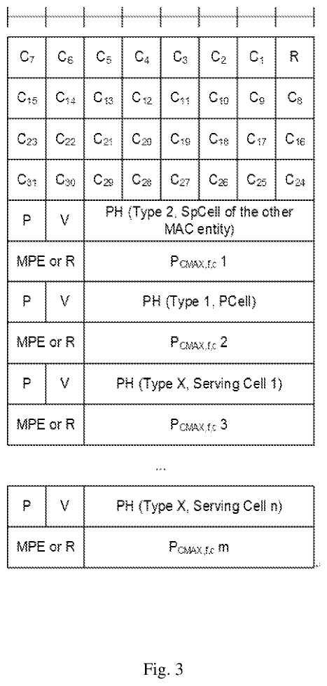

FIG. 2 illustrates a flowchart of a method 200 implemented at a terminal device according to some embodiments of the present disclosure. For the purpose of discussion, the method 200 will be described from the perspective of the terminal device 110 with reference to FIG. 1. It is to be understood that method 200 may further include additional blocks not shown and/or omit some shown blocks, and the scope of the present disclosure is not limited in this regard.

At block 210, the terminal device 110 may obtain a PH reporting indication, which indicates disabling cross cell group PH reporting, wherein PH information of activated serving cells of both the first cell group and the second cell group are reported in the cross cell group PH reporting. In other words, the terminal device 110 may determine whether there is a PH reporting indication from an explicit indication or configuration from the network device, or based on some implicit information, for example, an implicit signaling, or some related configuration parameters and a predetermined criteria.

In some embodiments, the PH reporting indication may be explicitly indicated by for example one or more bits indicating the disabling of cross cell group PH reporting. For example, the PH reporting indication can be explicitly indicated by a direct control bit in a PHR configuration. Such a bit can be a new bit or a reused bit in PHR configuration, or it could be a separate signaling, e.g. over RRC or MAC.

In some embodiments, the PH reporting indication may be implicitly indicated by one or more of: configuration of power control mode for the first cell group and the second cell group in semi-static mode; configuration of power limitation for the first cell group and the second cell group being less than or equal to the terminal device's transmission power; or inconsistence of PH report format configuration between the first cell group and the second cell group. In other words, the terminal device could obtain the PH reporting indication from some configuration parameters based on some predefined rules. For example, the terminal device may check the PHR mode, and when twoPHRMode is configured for a MAC entity, while there is/are cell(s) in another MAC entity configured with mTRP PUSCH repetition, it may determine that there is a PH reporting indication.

In some embodiments, the method 200 further comprises receiving, at the terminal device, a configuration regarding uplink power control or PHR configuration, wherein the PH reporting indication is obtained from the configuration.

In some embodiments, the method 200 further comprises triggering the PH report for one of the first cell group and the second cell group meeting a PHR trigger condition based on a PH reporting indication.

In some embodiments, the triggering the PH report comprises: determining the triggering by a Medium Access Control, MAC, entity of the first cell group or the second cell based on whether its respective cell group meets a PHR trigger condition; considering only serving cells or timers for the one of the first cell group and the second cell group. In other words, the MAC entity for MCG only considers conditions of its own cells in MCG when determining whether to trigger PHR for the MCG, while the MAC entity for SCG only considers conditions of its own cells in SCG when determining whether to trigger PHR. For example, the MAC entity only considers whether serving cells or timers of its own meet any case of triggering the PHR.

At block 220, the terminal device 110 may create, based on the PH reporting indication, PHR including PH information regarding one of the first cell group and the second cell group. In other words, the cross cell group PH report will be disabled.

In some embodiments, the creating a PH report further comprises including only PH information for activated serving cells of the one of the first cell group and the second cell group in the PH report. In an example, the PHR including only PH information of MCG when one or more of serving cells of MCG trigger a PH reporting. In another example, the PHR including only PH information of SCG when one or more of serving cells of SCG trigger PH reporting.

In some embodiments, the creating a PH report further comprises including PH information for serving cells of the one of the first cell group and the secondary cell group and PH information of a primary cell of the other of the second cell group and the second cell group in the PH report.

In embodiments of an explicit indication or signaling, it could ensure backward compatibility with UE since UE would report the PHR only if the network has configured the UE to do so. Regarding the above implicit indication, in principle, there is no backward compatibility issue, either, since there is a bitmap in the PHR MAC CE which can be used to indicate which PH of cells are reported.

As illustrated in FIG. 3, in the multiple entry PHR MAC CE format, a bitmap may be comprised in the PHR to indicate whether the serving cells is reported or not. The bitmap includes Cᵢ field and this Cᵢ filed in the bitmap indicates the presence of a PH field for a serving cell with ServCellIndex i. The Cᵢ field set to 1 indicates that a PH field for the serving cell with ServCellIndex i is reported. The Cᵢ field set to 0 indicates that a PH field for the serving cell with ServCellIndex i is not reported. Therefore, the MAC entity could indicate PH for cells for the other cell group as not reported.

However, in the bitmap, there is no bit for indication of a Primary cell and thus no bit can be used to indicate whether the PCell 121 or PScell 131 is reported in the bitmap. In such a case, in order to maintain the backward compatibility, it could be specified that PH information for PCell of the second cell group is still reported, for the case of implicit PH reporting indication. Such a solution can be considered for the case of partial disabling scheme.

Besides, to ensure backward compatibility with legacy node or LTE node, the PH for PCell could also be reported to MCG or SCG even for the case of explicit PH reporting indication.

In some embodiments, the method 200 may further comprise transmitting the PH report to the network device. In case of a PH reporting indication being obtained, it means a cross cell group PH reporting disabling is configured. In such a case, PH information of the cells associated with one of the cell groups (e.g., MCG or SCG) to another cell group (e.g., SCG or MCG), but a separate PH report shall be applied. For example, the PH report triggered by the MCG could comprise only PH information regarding cells in MCG and could be transmitted to MCG only, or alternatively, the PH report triggered by the SCG could comprise only PH information regarding cells in SCG and may be transmitted to the SCG only.

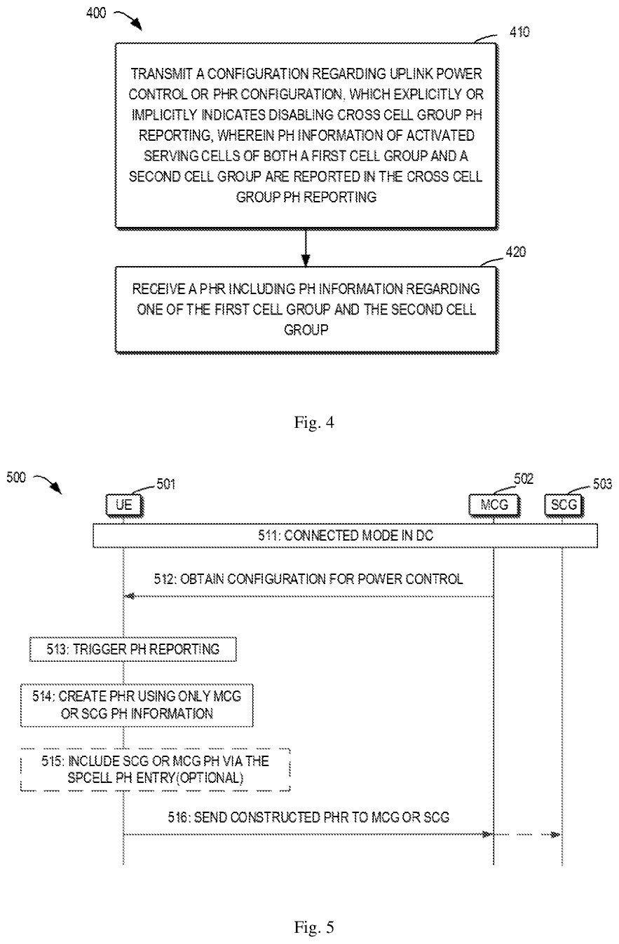

FIG. 4 illustrates a flowchart of a method 400 implemented at a network device in accordance with some embodiments of the present disclosure. For the purpose of discussion, the method 400 will be described from the perspective of the network device 120 or 130 with reference to FIG. 1. It is to be understood that method 400 may further include additional blocks not shown and/or omit some shown blocks, and the scope of the present disclosure is not limited in this regard.

At block 410, the network device 120 may transmit a configuration regarding uplink power control or PHR configuration, which explicitly or implicitly indicates disabling cross cell group PH reporting in which PH information of activated serving cells of both a first cell group and a second cell group are reported. In other words, the terminal device 110 can obtain explicit indication or implicit indication of disabling cross cell group PH reporting based on, for example, the configuration.

In some embodiments, the PH reporting indication is explicitly indicated by a bit indicating the disabling of cross cell group PH reporting in the configuration.

In some embodiments, wherein the PH reporting indication is implicitly indicated in the configuration by any or more of: configuration of power control mode for the first cell group and the second cell group in semi-static mode, configuration of power limitation for the first cell group and the second cell group being less than or equal to the terminal device's transmission power, or inconsistence of PH report format configuration between the first cell group and the second cell group.

At block 420, the network device 120 or 130 may receive a PHR including PH information regarding one of the first cell group and the second cell group.

In some embodiments, the PH report comprises only PH information for activated serving cells of the one of the first cell group and the second cell group in the PH report.

In some embodiments, the PH report comprises PH information for activated serving cells of the one of the first cell group and the second cell group and PH information of a primary cell the other of the first cell group and the second cell group in the PH report.

FIG. 5 illustrates a signaling chart illustrating an example PHR procedure in DC according to some example embodiments of the present disclosure. For the purpose of discussion, the process 500 will be described with reference to FIG. 1. For example, the device 110 is implemented by a UE 501 in FIG. 1, MCF 502 and SCG 503 can be implemented as the MCG and SCG in FIG. 1.

As shown in FIG. 5, at 511, the UE 501, MCG 502 and SCG 503 are in connected mode of dual connectivity. The UE 501 may connect to MCG 502 and SCG 503, simultaneously, such that MCG 502 and SCG 503 provide communication resource to UE 401.

At 512, the UE 501 may obtain configuration for power control. In some example embodiments, the configuration includes information of UE transmit power limitation, inconsistence of PH report format configuration between MCG 502 and SCG 503, and so on. For example, MCG 502 and SCG 503 can measure path loss of severing cells to determine MCG 502 and SCG 503 uplink transmit power, MCG 502 then transmits the information of path loss to UE 501 in the configuration.

At 513, the UE 501 may trigger PH reporting based on the configuration including information of disabling cross cell group PH reporting. For example, the UE 501 may trigger PH reporting for one of MCG 502 and SCG 503 when the change of path loss for any serving cell of any MAC entity exceeds the threshold. In some example embodiments, cross cell group PH reporting may be disabled by explicit disabling with separate signaling, e.g., over RRC or MAC. In some example embodiments, cross cell group PH reporting may be disabled by implicit disabling based on following one or more of: configuration of power control mode for the first cell group and the second cell group in semi-static mode; configuration of power limitation for the first cell group and the second cell group being less than or equal to the terminal device's transmission power; or inconsistence of PH report format configuration between the first cell group and the second cell group.

At 414, the UE 501 may create PHR using only MCG 502 or SCG 503 PH information based on the configuration. In some example embodiments, the UE 501 may create PHR of MCG 502 when one or more of serving cells of MCG 502 trigger PH reporting, and create PHR of SCG 503 when one or more of serving cells of SCG 503 trigger PH reporting.

At 515, the UE 501 may include SCG 503 or MCG 502 PH via the SPcell PH entry, alternatively. In some example embodiments, UE 501 may include PScell 131 PH entry into the PHR of MCG 502 when one or more of serving cell of MCG 502 trigger PH reporting. In some example embodiments, UE 501 may include Pcell 121 PH entry into the PHR of SCG 503 when one or more of serving cells of SCG 503 trigger PH reporting.

Then, at 516, the UE 501 may send constructed PHR to MCG 502 or SCG 503. In some example embodiments, the UE 501 may send constructed PHR to MCG 502 when one or more of serving cell of MCG 502 trigger PH reporting. In some example embodiments, the UE 501 may send constructed PHR to SCG 503 when one or more of serving cells of SCG 503 trigger PH reporting.

Operations and features as described above with reference to FIGS. 1-4 are likewise applicable to the process 500 and have similar effects. For the purpose of simplification, the details will be omitted.

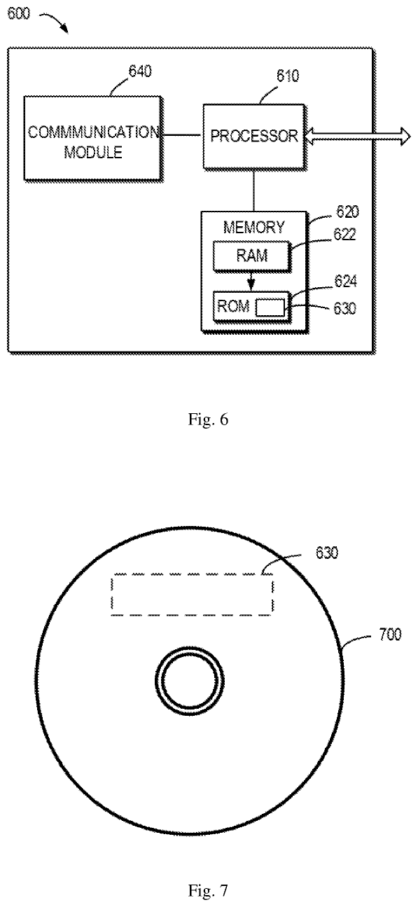

FIG. 6 is a simplified block diagram of a device 600 that is suitable for implementing embodiments of the present disclosure. The device 600 may be provided to implement the communication device, for example the terminal device 110, the network device 120 or the network device 130 as shown in FIG. 1. As shown, the device 600 includes one or more processors 610, one or more memories 620 coupled to the processor 610, and one or more transmitters and/or receivers (TX/RX) 640 coupled to the processor 610.

The TX/RX 640 is for bidirectional communications. The TX/RX 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 6 may perform any suitable actions and processing by loading the program 630 into the RAM 622.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300 or 400, or procedure 500 as described above with reference to FIGS. 2-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-19. (canceled)

20. A terminal device, comprising:
one or more transceivers; and
one or more processors communicatively coupled to the one or more transceivers, and the one or more processors are configured to cause the terminal device to:
obtain a power headroom reporting indication, which indicates disabling cross cell group power headroom reporting, wherein the terminal device is configured with dual connectivity with a first cell group and a second cell group, and wherein power headroom information of activated serving cells of both the first cell group and the second cell group are reported in the cross cell group power headroom reporting; and
create, based on the power headroom reporting indication, a power headroom report including power headroom information regarding one of the first cell group and the second cell group.

21. The terminal device of claim 20, wherein the power headroom reporting indication is explicitly indicated by a bit indicating the disabling of cross cell group power headroom reporting.

22. The terminal device of claim 20, wherein the power headroom reporting indication is implicitly indicated by one or more of:
configuration of power control mode for the first cell group and the second cell group in semi-static mode;
configuration of power limitation for the first cell group and the second cell group being less than or equal to the terminal device's transmission power; or
inconsistence of power headroom report format configuration between the first cell group and the second cell group.

23. The terminal device of claim 20, wherein the terminal device is further caused to: receive a configuration regarding uplink power control or power headroom report configuration, wherein the power headroom reporting indication is obtained from the configuration.

24. The terminal device of claim 20, wherein the creating a power headroom report comprises including only power headroom information for activated serving cells of the one of the first cell group and the second cell group in the power headroom report.

25. The terminal device of claim 20, wherein the creating a power headroom report comprises including power headroom information for activated serving cells of the one of the first cell group and the second cell group and power headroom information of a primary cell of the other of the first cell group and the second cell group in the power headroom report.

26. The terminal device of claim 20, wherein the terminal device is further caused to trigger the power headroom report for one of the first cell group and the second cell group meeting a power headroom report trigger condition based on the power headroom reporting indication.

27. The terminal device of claim 26, wherein the triggering the power headroom report comprises
determining the triggering by a Medium Access Control, MAC, entity of the first cell group or the second cell based on whether its respective cell group meets a power headroom report trigger condition.

28. The terminal device of claim 20, wherein the terminal device is further caused to transmit the power headroom report to the network device.

29. A network device, comprising:
one or more transceivers; and
one or more processers communicatively coupled to the one or more transceivers, and configured to cause the network device to:
transmit a configuration regarding uplink power control or power headroom report configuration, which explicitly or implicitly indicates disabling cross cell group power headroom reporting, wherein power headroom information of activated serving cells of both a first cell group and a second cell group are reported in the cross cell group power headroom reporting; and
receive a power headroom report including power headroom information regarding one of the first cell group and the second cell group.

30. The network device of claim 29, wherein the power headroom reporting indication is explicitly indicated by a bit indicating the disabling of cross cell group power headroom reporting in the configuration.

31. The network device of claim 29, wherein the power headroom reporting indication is implicitly indicated in the configuration by any or more of:
configuration of power control mode for the first cell group and the second cell group in semi-static mode,
configuration of power limitation for the first cell group and the second cell group being less than or equal to the terminal device's transmission power, or
inconsistence of power headroom report format configuration between the first cell group and the second cell group.

32. The network device of claim 29, wherein the power headroom report comprises only power headroom information for activated serving cells of the one of the first cell group and the second cell group in the power headroom report.

33. The network device of claim 29, wherein the power headroom report comprises power headroom information for activated serving cells of the one of the first cell group and the second cell group and power headroom information of a primary cell of the other of the first cell group and the second cell group in the power headroom report.

34. A method at a terminal device, comprising:
obtaining a power headroom reporting indication, which indicates disabling cross cell group power headroom reporting, wherein the terminal device is configured with dual connectivity with a first cell group and a second cell group, and wherein power headroom information of activated serving cells of both the first cell group and the second cell group are reported in the cross cell group power headroom reporting; and
creating, based on the power headroom reporting indication, a power headroom report including power headroom information regarding one of the first cell group and the second cell group.

35. The method of claim 34, wherein the power headroom reporting indication is explicitly indicated by a bit indicating the disabling of cross cell group power headroom reporting.

36. The method of claim 34, wherein the power headroom reporting indication is implicitly indicated by one or more of:
configuration of power control mode for the first cell group and the second cell group in semi-static mode;
configuration of power limitation for the first cell group and the second cell group being less than or equal to the terminal device's transmission power; or
inconsistence of power headroom report format configuration between the first cell group and the second cell group.

37. The method of claim 34, wherein the creating a power headroom report comprises including only power headroom information for activated serving cells of the one of the first cell group and the second cell group in the power headroom report.

38. The method of claim 34, wherein the creating a power headroom report comprises including power headroom information for activated serving cells of the one of the first cell group and the second cell group and power headroom information of a primary cell of the other of the first cell group and the second cell group in the power headroom report.

39. The method of claim 34, further comprising triggering the power headroom report for one of the first cell group and the second cell group meeting a power headroom report trigger condition based on the power headroom reporting indication.
